(19) United States
(12) Patent Application Publication
(10) Pub. No.: US 2007/0149162 A1
(43) Pub. Date: Jun. 28, 2007

(54) Pulse transmission method

(75) Inventors: Charles E. Greene, Pittsburgh, PA (US); John G. Shearer, Ligonier, PA (US); Daniel W. Harrist, Carnegie, PA (US)

Correspondence Address: Ansel M. Schwartz;Attorney at Law, Suite 304, 201 N. Craig Street, Pittsburgh, PA, 15213, US

(73) Assignee: Powercast, LLC

(21) Appl. No.: 11/651,818

(22) Filed: Jan. 10, 2007

Related U.S. Application Data
(63) Continuation-in-part of application No. 11/356,892, filed on Feb. 16, 2006.
(60) Provisional application No. 60/656,165, filed on Feb. 24, 2005.

(51) Int. Cl. H04B 1/10; H04B 1/16; H04B 1/38; H04M 1/00

(52) U.S. Cl. 455/343.1; 455/299; 455/572

(57) ABSTRACT

Disclosed is a transmitter for transmitting power wirelessly to a receiver to power a load comprises a pulse generator for producing pulses of power. The transmitter comprises a power sensor which can sense when other transmitters are transmitting in order for the generator to transmit the pulses at the appropriate time. Disclosed is a power sensor for a pulse generator of a transmitter which can sense when other transmitters are transmitting in order for the generator to transmit the pulses at the appropriate time. Disclosed is a system for power transmission. Disclosed is a method for transmitting power to a receiver to power a load. Disclosed is an apparatus for transmitting power to a receiver to power a load. Disclosed is a system for power transmission.

### BACKGROUND OF THE INVENTION

1. Field of the Invention

The present invention is related to wireless power transmission to a receiver to power a load. More specifically, the present invention is related to wireless power transmission by a transmitter to a receiver to power a load using a power sensor which can sense when other transmitters are transmitting in order for the transmitter to transmit the pulses at the appropriate time.

2. Description of Related Art

Current methods of Radio Frequency (RF) power transmission use a Continuous Wave (CW) system. This means a transmitter continuously supplies a fixed amount of power to a remote unit (antenna, rectifier, device). However, a rectifier has an efficiency that is proportional to the power received by an antenna. To combat this problem, a new method of power transmission was developed that involves pulsing the transmitted power (On-Off Keying (OOK) the carrier frequency).

### BRIEF SUMMARY OF THE INVENTION

The present invention pertains to a transmitter for transmitting power wirelessly to a receiver to power a load. The transmitter comprises a pulse generator for producing pulses of power. The transmitter comprises a power sensor which can sense when other transmitters are transmitting in order for the generator to transmit the pulses at the appropriate time.

The present invention pertains to a power sensor for a pulse generator of a transmitter which can sense when other transmitters are transmitting in order for the generator to transmit the pulses at the appropriate time. The sensor comprises an antenna. The sensor comprises an analog to digital converter or a voltage comparator or an input pin.

The present invention pertains to a system for power transmission. The system comprises a transmitter which transmits pulses of power and which senses when other transmitters are transmitting in order for the generator to transmit the pulses at the appropriate time. The system comprises a receiver which receives the pulses of power transmitted by the power transmitter to power a load.

The present invention pertains to a method for transmitting power to a receiver to power a load. The method comprises the steps of producing pulses of power with a pulse generator. There is the step of transmitting the pulses based on a power sensor which can sense when other transmitters are transmitting in order for the generator to transmit the pulses at the appropriate time.

The present invention pertains to an apparatus for transmitting power to a receiver to power a load. The apparatus comprises a plurality of transmitters, each of which produce pulses of power and each of which having an associated sensor that can sense when the transmitters are producing the pulses so the associated transmitter can transmit the pulses at the appropriate time which are received by the receiver to power the load.

The present invention pertains to a method for transmitting power to a receiver to power a load. The method comprises the steps of producing pulses of power from a plurality of transmitters each having an associated sensor that can sense when the transmitters are producing the pulses so the associated transmitter can transmit the pulses at the appropriate time which are received by the receiver to power the load.

The present invention pertains to a system for power transmission. The system comprises a transmitter which transmits pulses of power having an average transmitted power. The system comprises a receiver which receives the pulses of power transmitted by the power transmitter to power a load. The pulses produced by the transmitter yielding voltages at the receiver which are higher than continuous-wave systems having the same average transmitted power as the transmitter.

The present invention pertains to a system for power transmission. The system comprises a transmitter which transmits pulses of power. The system comprises a receiver adapted to be disposed in a patient which receives the pulses of power transmitted by the power transmitter to power a load.

The present invention pertains to a system for power transmission. The system comprises a transmitter which transmits pulses of power having an average transmitted power. The system comprises a receiver which receives the pulses of power transmitted by the power transmitter to power a load. The pulses produced by the transmitter yielding instantaneous open circuit voltages at the receiver which are higher than continuous-wave systems having the same average transmitted power as the transmitter enabling battery recharging at greater distance.

The present invention pertains to a system for power transmission. The system comprises a transmitter which transmits pulses of power having an average transmitted power. The system comprises a receiver which receives the pulses of power transmitted by the power transmitter to power a load. The pulses produced by the transmitter yielding instantaneous open circuit voltages at the receiver which are higher than continuous-wave systems having the same average transmitted power as the transmitter enabling direct powering at greater distance.

The present invention pertains to a system for power transmission. The system comprises a transmitter which transmits pulses of power. The system comprises a receiver which receives the pulses of power transmitted by the power transmitter to power a load and transmits data when the transmitter is not transmitting a pulse.

The present invention pertains to a method for transmitting power wirelessly to a receiver. The method comprises the steps of sensing power by an RF power sensor. There is the step of transmitting power wirelessly by a transmitter if the power sensed by the sensor is below a threshold.

The present invention pertains to a system for power transmission. The system comprises a transmitter that produces pulses of power. The system comprises a receiver that is located inside or behind an attenuating medium. The receiver receives the pulses of power in order to power a load.

The present invention pertains to a system for power transmission. The system comprises a transmitter that produces output power having an average value. The system comprises a receiver that receives the output power in order to power a load. The load is powered at distances greater than those obtained by a continuous-wave system at an average power level that is the same as the average value.

The present invention pertains to a receiver which wirelessly receives pulses of power. The receiver comprises a rectifier which receives the pulses of power, the pulses yielding voltages at the receiver which are higher than continuous-wave power having the same average power as the pulses. The receiver comprises a storage device in electrical communication with the rectifier which is powered by the rectifier and provides a predetermined continuous level of power. The receiver comprises a load in electrical communication with the storage device and receiving power from the storage device.

The present invention pertains to a receiver which wirelessly receives pulses of power. The receiver comprises a rectifier which receives the pulses of power, the pulses yielding instantaneous open circuit voltages at the receiver which are higher than continuous-wave power having the same average power as the pulses enabling battery recharging at greater distance. The receiver comprises a battery in electrical communication with the rectifier and receiving power from the rectifier.

The present invention pertains to a receiver which wirelessly receives pulses of power. The receiver comprises a rectifier which receives the pulses of power, the pulses yielding instantaneous open circuit voltages at the receiver which are higher than continuous-wave power having the same average power as the pulses enabling direct powering at greater distance. The receiver comprises a storage device in electrical communication with the rectifier which is powered by the rectifier and provides a predetermined continuous level of power. The receiver comprises a load in electrical communication with the storage device and receiving power from the storage device. The receiver comprises a load in electrical communication with the storage device and receiving power from the storage device.

The present invention pertains to a method for using pulses of power received wirelessly by a receiver. The method comprises the steps of receiving the pulses of power by a rectifier of the receiver. There is the step of providing by the rectifier energy from the pulses of power. There is the step of powering a load with the energy from the rectifier.

### BRIEF DESCRIPTION OF THE SEVERAL VIEWS OF THE DRAWINGS

FIGS. 1a-1d are a pictorial explanation of the pulse transmission technique of the present invention.

FIG. 2 is a block diagram of a transmission system of the present invention.

FIG. 3 shows how a pulsed waveform is constructed using a carrier frequency.

FIG. 4 shows an example of battery recharging with a pulsed transmission method system.

FIG. 5 is a block diagram of a receiver with a clock generator.

FIG. 6a and FIG. 6b is a block diagram of a multiple transmitter, single frequency, multiple timeslots embodiment; and an associated pulse as a function of time, respectively.

FIG. 7 is a block diagram of a timeslots selector implemented using an RF power sensor including an RF energy harvesting circuit.

FIG. 8 is a block diagram of a microprocessor in communication with the RF power sensor for control of the RF power transmitter.

FIG. 9 is an algorithm that may be used by the controlling microcontroller.

FIG. 10 is a block diagram of an RF power sensor connected to a circuit used to provide a digital signal to a microprocessor for control of an RF power transmitter.

FIG. 11a and FIG. 11b is a block diagram of an RF power sensor implemented with a separate antenna, and an RF power sensor implemented with the RF power transmitting antenna, respectively.

FIG. 12 is a block diagram of multiple transmitters, multiple frequencies, no timeslots embodiment of the present invention.

FIG. 13a and FIG. 13b is a block diagram of a single transmitter, single frequency, non-return to zero embodiment of the present invention, and the associated power versus time graph, respectively.

FIGS. 14a and 14b is a block diagram of a single transmitter, multiple frequencies, multiple timeslots embodiment of the present invention, and the associated power versus time graph, respectively.

FIGS. 15a and 15b is a block diagram of multiple transmitters, single frequency, multiple timeslots embodiment of the present invention, and the associated power versus time graphs, respectively.

FIGS. 16a and 16b is a block diagram of single transmitter, multiple frequencies, multiple timeslots non-return to zero embodiment of the present invention, and the associated power versus time graph, respectively

FIGS. 17a and 17b is a block diagram of a single transmitter, multiple frequencies, multiple timeslots, return to zero embodiment of the present invention, and the associated power versus time graph, respectively.

FIG. 18 is a block diagram of multiple transmitters, multiple frequencies, no timeslots, varied amplitude embodiment of the present invention.

FIGS. 19a and 19b is a block diagram of multiple transmitters, multiple frequencies, multiple timeslots, varied amplitude, and associated power versus time graphs, respectively.

FIG. 20 is a block diagram of a receiver including data extracting apparatus.

FIG. 21 shows a body and an attenuating medium in regard to the present invention.

### DETAILED DESCRIPTION OF THE INVENTION

A complete understanding of the invention will be obtained from the following description when taken in connection with the accompanying drawing figures wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

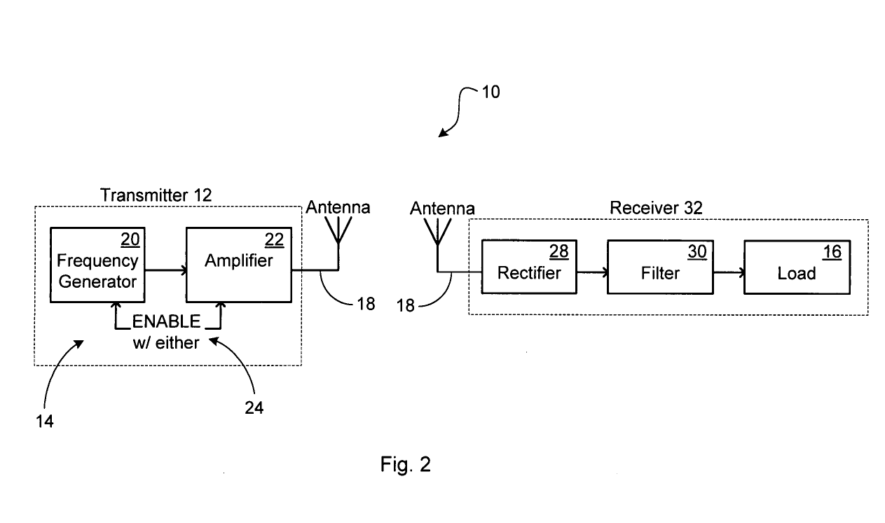

Referring to FIGS. 2, 8, 11a and 11b, there is shown a transmitter 12 for transmitting power wirelessly to a receiver 32 to power a load 16. The transmitter 12 comprises a pulse generator 14 for producing pulses of power. The transmitter 12 comprises a power sensor 46 which can sense when other transmitters are transmitting in order for the generator to transmit the pulses at the appropriate time.

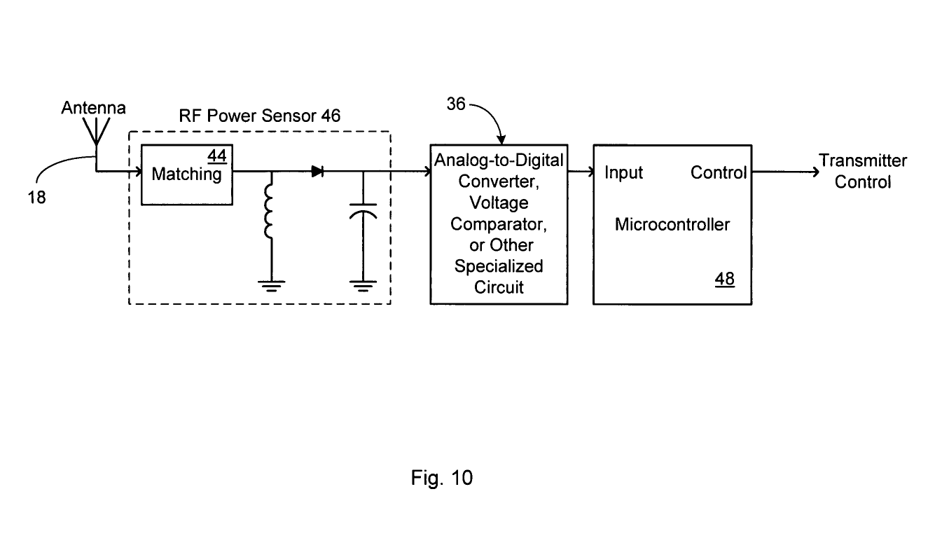

Preferably, the power sensor 46 is in communication with the pulse generator 14. Alternatively, the power sensor 46 is in communication with a microcontroller 48 controlling the pulse generator 14. Alternatively, the power sensor 46 is in communication with an analog to digital converter 36 in communication with a microcontroller 48 controlling the pulse generator 14, as shown in FIG. 10.

The pulse generator 14 can include a frequency generator 20 having an output, and an amplifier 22 in communication with the frequency generator 20 and an antenna 18. There can be an enabler 24 which controls the frequency generator 20 or the amplifier 22 to form the pulses. The enabler 24 preferably defines a time duration between pulses.

The time duration is preferably greater than one-half of one cycle of the frequency generator 20 output.

The power of the transmitted pulses can be equivalent to an average power of a continuous wave power transmission system. The average power Pavg of the pulses is preferably determined by

$${P}_{AVG} = \frac{{P}_{PEAK} ( {T}_{PULSE} )}{{T}_{PERIOD}} .$$

The pulse generator 14 can produce a continuous amount of power between pulses. The pulse generator 14 can produce pulses at different output frequencies sequentially. Alternatively, the pulse generator 14 can produces pulses at different amplitudes. The pulse generator 14 can include a plurality of frequency generators 20, an amplifier 22, and a frequency selector 39 in communication with the frequency generators 20 and the amplifier 22, that determines and routes the correct frequency from the frequency generators 20 to the amplifier 22.

The pulse generator 14 can transmit data between the pulses. The pulse generator 14 can transmit data in the pulses. The transmitter 12 can include a gain control 26 which controls the frequency generator 20 or the amplifier 22 to form the pulses. The gain control 26 can define a time duration between pulses.

The present invention pertains to a power sensor 46 for a pulse generator 14 of a transmitter 12 which can sense when other transmitters are transmitting in order for the generator to transmit the pulses at the appropriate time, as shown in FIG. 10. The sensor 46 comprises an antenna 18. The sensor 46 comprises an analog to digital converter 36 or a voltage comparator or an input pin, as shown in FIG. 10.

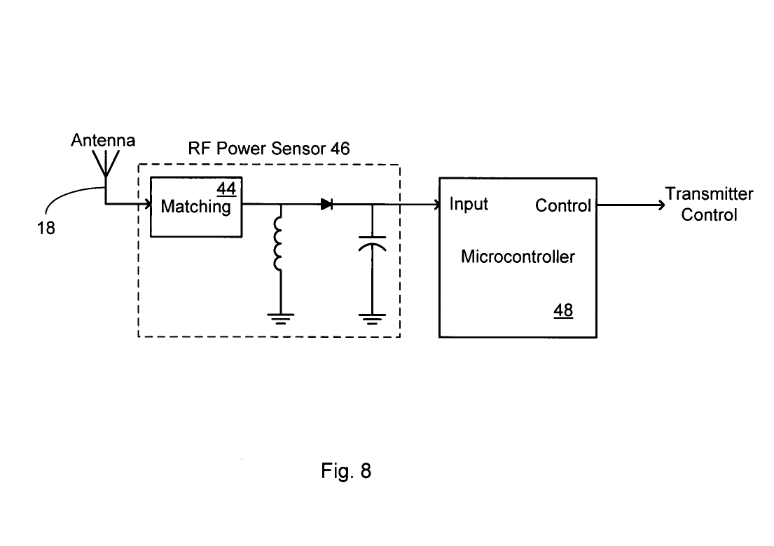

The present invention pertains to a system 10 for power transmission. The system 10 comprises a transmitter 12 which transmits pulses of power and which senses when other transmitters are transmitting in order for the generator to transmit the pulses at the appropriate time, as shown in FIGS. 2 and 8. The system 10 comprises a receiver 32 which receives the pulses of power transmitted by the power transmitter 12 to power a load 16. Preferably, the receiver 32 transmits data when the transmitter 12 is not transmitting a pulse.

The present invention pertains to a method for transmitting power to a receiver 32 to power a load 16. The method comprises the steps of producing pulses of power with a pulse generator 14. There is the step of transmitting the pulses based on a power sensor 46 which can sense when other transmitters are transmitting in order for the generator to transmit the pulses at the appropriate time.

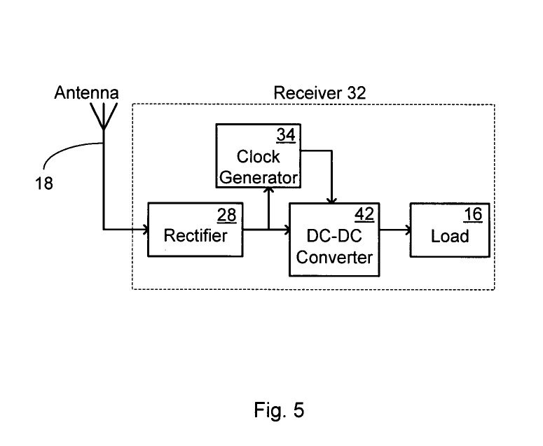

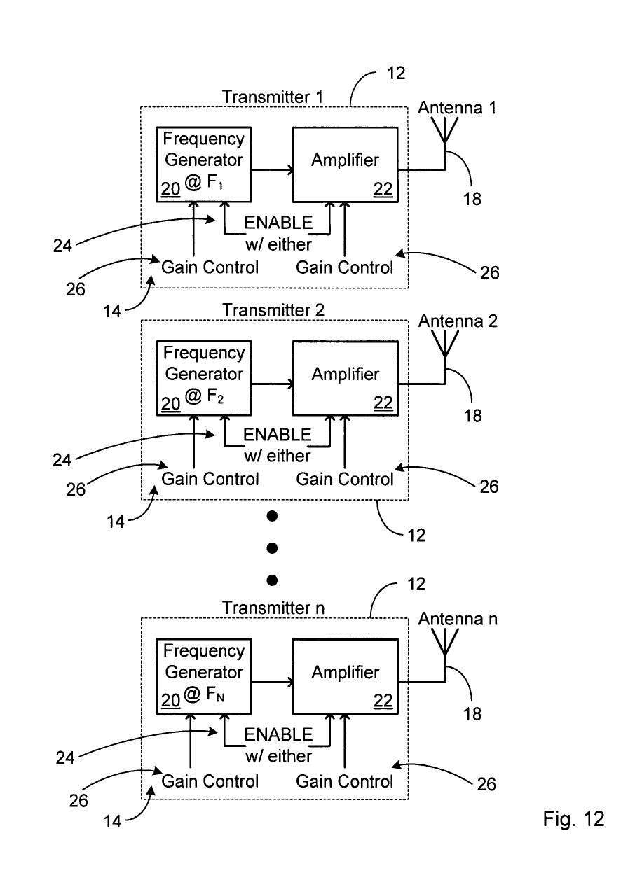

The present invention pertains to an apparatus for transmitting power to a receiver 32 to power a load 16, as shown in FIGS. 5 and 12. The apparatus comprises a plurality of transmitters 12, each of which produce pulses of power and each of which having an associated sensor 46 that can sense when the transmitters 12 are producing the pulses so the associated transmitter 12 can transmit the pulses at the appropriate time which are received by the receiver 32 to power the load 16.

The present invention pertains to a method for transmitting power to a receiver 32 to power a load 16. The method comprises the steps of producing pulses of power from a plurality of transmitters 12 each having an associated sensor 46 that can sense when the transmitters 12 are producing the pulses so the associated transmitter 12 can transmit the pulses at the appropriate time which are received by the receiver 32 to power the load 16.

The present invention pertains to a system 10 for power transmission, as shown in FIG. 2. The system 10 comprises a transmitter 12 which transmits pulses of power having an average transmitted power. The system 10 comprises a receiver 32 which receives the pulses of power transmitted by the power transmitter 12 to power a load 16. The pulses produced by the transmitter 12 yielding voltages at the receiver 32 which are higher than continuous-wave systems having the same average transmitted power as the transmitter 12.

The present invention pertains to a system 10 for power transmission. The system 10 comprises a transmitter 12 which transmits pulses of power. The system 10 comprises a receiver 32 adapted to be disposed in a patient which receives the pulses of power transmitted by the power transmitter 12 to power a load 16. FIG. 21 shows a body 52, here of a patient, and an attenuating medium 54 (the same thing in this fig) in regard to the system 10. The receiver 32 has an antenna 18 disposed in the patient.

The present invention pertains to a system 10 for power transmission. The system 10 comprises a transmitter 12 which transmits pulses of power having an average transmitted power. The system 10 comprises a receiver 32 which receives the pulses of power transmitted by the power transmitter 12 to power a load 16. The pulses produced by the transmitter 12 yielding instantaneous open circuit voltages at the receiver 32 which are higher than continuous-wave systems having the same average transmitted power as the transmitter 12 enabling battery recharging at greater distance.

The present invention pertains to a system 10 for power transmission. The system 10 comprises a transmitter 12 which transmits pulses of power having an average transmitted power. The system 10 comprises a receiver 32 which receives the pulses of power transmitted by the power transmitter 12 to power a load 16. The pulses produced by the transmitter 12 yielding instantaneous open circuit voltages at the receiver 32 which are higher than continuous-wave systems having the same average transmitted power as the transmitter 12 enabling direct powering at greater distance.

The present invention pertains to a system 10 for power transmission. The system 10 comprises a transmitter 12 which transmits pulses of power. The system 10 comprises a receiver 32 which receives the pulses of power transmitted by the power transmitter 12 to power a load 16 and transmits data when the transmitter 12 is not transmitting a pulse.

The present invention pertains to a method for transmitting power wirelessly to a receiver 32. The method comprises the steps of sensing power by an RF power sensor 46. There is the step of transmitting power wirelessly by a transmitter 12 if the power sensed by the sensor 46 is below a threshold. Preferably, there is the step of waiting to transmit power wirelessly by the transmitter 12 if the power sensed by the sensor 46 is above the threshold.

The present invention pertains to a system 10 for power transmission. The system 10 comprises a transmitter 12 that produces pulses of power. The system 10 comprises a receiver 32 that is located inside or behind an attenuating medium. The receiver 32 receives the pulses of power in order to power a load 16.

The present invention pertains to a system 10 for power transmission. The system 10 comprises a transmitter 12 that produces output power having an average value. The system 10 comprises a receiver 32 that receives the output power in order to power a load 16. The load 16 is powered at distances greater than those obtained by a continuous-wave system at an average power level that is the same as the average value. The load 16 may be a battery, a circuit, or an LED.

The present invention pertains to a receiver 32 which wirelessly receives pulses of power. The receiver 32 comprises a rectifier 28 which receives the pulses of power, the pulses yielding voltages at the receiver 32 which are higher than continuous-wave power having the same average power as the pulses. The receiver 32 comprises a storage device in electrical communication with the rectifier 28 which is powered by the rectifier 28 and provides a predetermined continuous level of power. The receiver 32 comprises a load 16 in electrical communication with the storage device and receiving power from the storage device.

The present invention pertains to a receiver 32 which wirelessly receives pulses of power. The receiver 32 comprises a rectifier 28 which receives the pulses of power, the pulses yielding instantaneous open circuit voltages at the receiver 32 which are higher than continuous-wave power having the same average power as the pulses enabling battery recharging at greater distance. The receiver 32 comprises a battery in electrical communication with the rectifier 28 and receiving power from the rectifier 28. In addition to the battery, there can be a storage device in electrical communication with the rectifier 28 and the battery which is powered by the rectifier 28 and provides a predetermined continuous level of power to the battery.

The present invention pertains to a receiver 32 which wirelessly receives pulses of power. The receiver 32 comprises a rectifier 28 which receives the pulses of power, the pulses yielding instantaneous open circuit voltages at the receiver 32 which are higher than continuous-wave power having the same average power as the pulses enabling direct powering at greater distance. The receiver 32 comprises a storage device in electrical communication with the rectifier 28 which is powered by the rectifier 28 and provides a predetermined continuous level of power. The receiver 32 comprises a load 16 in electrical communication with the storage device and receiving power from the storage device.

The present invention pertains to a method for using pulses of power received wirelessly by a receiver 32. The method comprises the steps of receiving the pulses of power by a rectifier 28 of the receiver 32. There is the step of providing by the rectifier 28 energy from the pulses of power. There is the step of powering a load 16 with the energy from the rectifier 28.

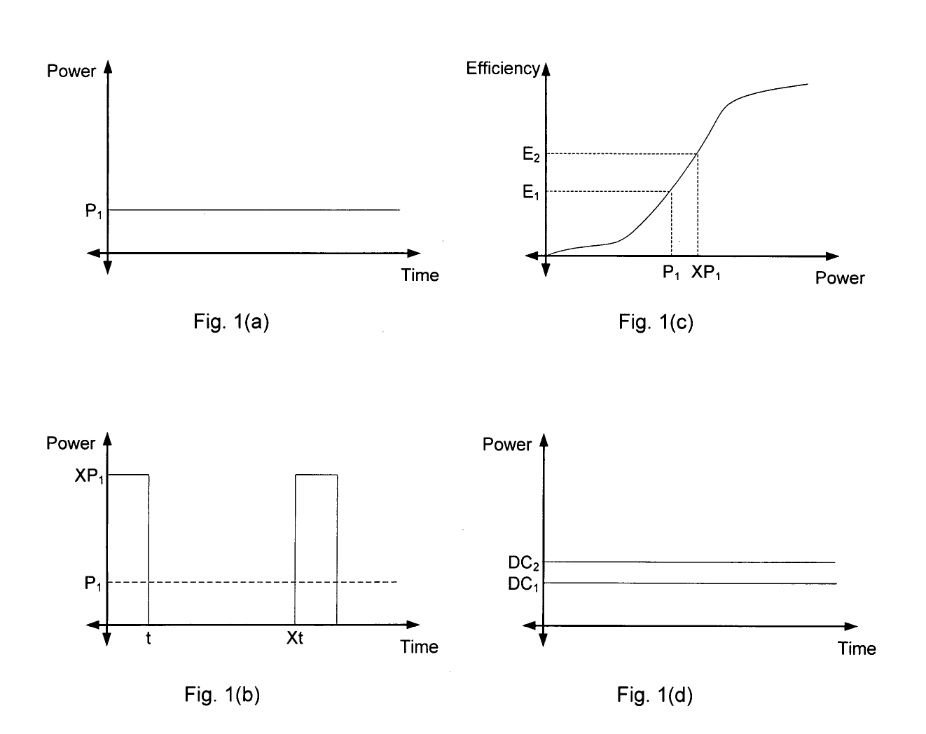

In the operation of the invention, current methods of Radio Frequency (RF) power transmission use a Continuous Wave (CW) system or fixed output power. This means the transmitter continuously supplies a fixed amount of power to a remote unit (antenna, rectifier, device). However, the rectifier has an efficiency that is proportional to the power received by the antenna. To combat this problem, a new method of power transmission was developed that involves pulsing the transmitted power (On-Off Keying (OOK) the carrier frequency). Pulsing the transmission allows higher peak power levels to obtain an average value equivalent to a CW system. This concept is illustrated in FIG. 1. It should be noted that each pulse may have different amplitudes and that the amplitude of each pulse may vary over the duration of the pulse. This means that the amplitude can take several shapes over the duration of the pulse including, but not limited to, a constant line shape, an increasing or decreasing ramp shape, a square-wave shape, a sine-wave shaped, a sine-squared-wave shape, or any other shape.

As shown in FIG. 1a, the CW system supplies a fixed/average power of P₁. The rectifying circuit, therefore, converts the received power at an efficiency of E₁ as shown in FIG. 1c. The pulsed transmission method (PTM), which is shown in FIG. 1b, also has an average power of P₁, however it is not fixed. Instead, the power is pulsed at X times P₁ to obtain an average of P₁. This allows the system 10 to be equivalent to the CW systems when evaluated by regulatory agencies. The main benefit of this method is the increase in the efficiency of the rectifying circuit to E₂. This means the device will see an increase in the power and voltage available even though the average transmitting power remains constant for both systems. The increase in Direct Current (DC) power can be seen in FIG. 1d where E₁ and E₂ correspond to DC₁ and DC₂, respectively. A block diagram representation of this system 10 can be seen in FIG. 2. The receiving circuit can take many different forms. One example of a functional device is given in U.S. Pat. No. 6,615,074 (Apparatus for Energizing a Remote Station and Related Method).

The pulsing is accomplished by first enabling both the frequency generator 20 and the amplifier 22. Then the enable line, which will be enabled at this point, will be toggled on either the Frequency generator 20 or the Amplifier 22 to disable then re-enable one of the devices. This action will produce the pulsed output. As an example, if the enable line on the Frequency generator 20 is toggled ON and OFF, this would correspond to producing RF energy followed by no RF energy. It should be noted that the frequency generator 20 and the amplifier 22 and the process of enabling and disabling may be referred to as the pulse generator 14 or RF power transmitter 12.

To distinguish the PTM from a CW system, it becomes necessary to define the minimum duration between pulses. This time will be a function of the transmitting frequency, and would be limited to one half of one cycle of the output from the frequency generator 20. It would be possible to decrease the OFF time further but switching during a positive or negative swing would produce harmonics that would be delivered to the antenna 18. This would mean frequencies other than the carrier would also be transmitted, leading to possible interference with other frequency bands. However, practically switching at such high rates will not be advantageous. The response times for the Frequency generator 20, Amp, and Rectifier 28 will almost always be longer than the short durations described. This means the system 10 would not be able to respond to changes that quickly, and benefits of the PTM system 10 would be degraded.

Examples of each block are as follows.

TABLE 1
Descriptions for FIG. 2 Blocks

| Block | Examples |
|---|---|
| Frequency Generator | RF Signal Generator (Agilent 8648), |
| | Phase-Locked Loop (PLL), Oscillator |
| Amplifier | Amplifier Research 5W1000, MHL9838 |
| Rectifier | Full-wave, Half-wave, Specialized |
| Filter | Capacitor, L-C |
| Load | Device, Battery, Resistor, LED |

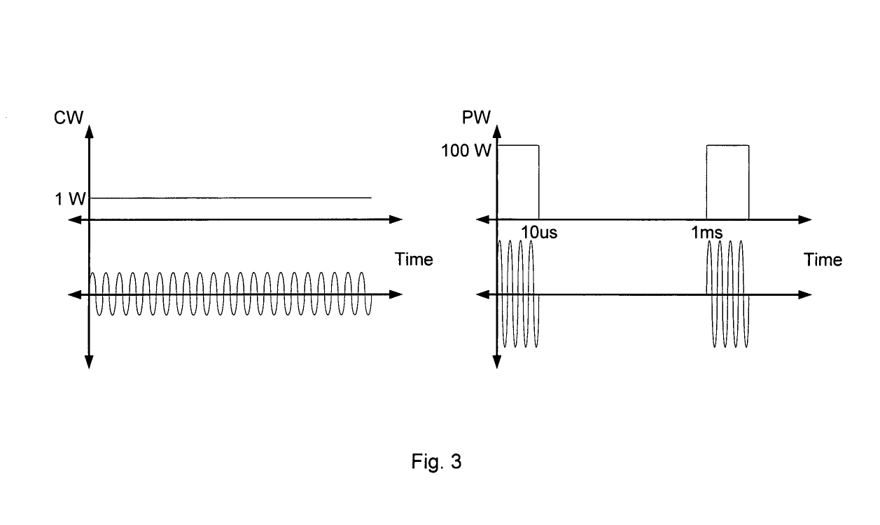

FIG. 3 shows how the pulsed waveform is constructed using the carrier frequency. As can be seen, the pulse simply tells the duration and amplitude of the transmitted frequency. Also illustrated, is a simple equation for determining the average power of the pulsed transmission. The resulting average of the pulsed signal is equivalent to the CW signal.

$$\begin{matrix}{P}_{AVG} = \frac{{P}_{PEAK} ( {T}_{PULSE} )}{{T}_{PERIOD}} \\ = \frac{100 W ( 10 µs )}{1 ms} \\ = \frac{1000 \times {10}^{- 6}}{1 \times {10}^{- 3}} \\ = 1 Watt\end{matrix} \qquad ( 1 )$$

One example of where this method could be used is in the 890-940 MHz range. The Federal Communications Commission (FCC) lists requirements for operation in this band in Section 15.243 of the Code of Federal Regulations (CFR), Title 47. This specification appears in Appendix A. The regulations for this band specify that the emission limit is measured with an average detector, and peak transmissions are limited by Section 15.35, which appears in Appendix B. This regulation states that the peak emission is limited to 20 dB (100 times) the average power stated for that frequency band. This would correspond to a limit of X=100 in FIG. 1b.

Another application for the PTM is in the charging or recharging of a power storage device, which may include, but is not limited to, a battery, a capacitor, or any other power storage device. The PTM is well suited to charge or recharge power storage devices because any circuits designed for receiving RF power placed in the PTM power field with a given average output power will produce a higher open-circuit voltage than those placed in CW power fields with the same average output power at any distance from the transmitter 12. The open-circuit voltage refers to the voltage that is read across the receiver 32 circuit's output without said output being connected to any load 16, hence open-circuit. The open-circuit voltage depends on the amount of power available to the circuit designed for receiving RF power. In a PTM power transmission system 10, the peak power that is output is much higher than that of a CW power transmission system with the same average output power. This open-circuit voltage is critical to charging and recharging power storage devices because if the open-circuit voltage is less than the voltage on the power storage device, there will be no charge transferred to the power storage device.

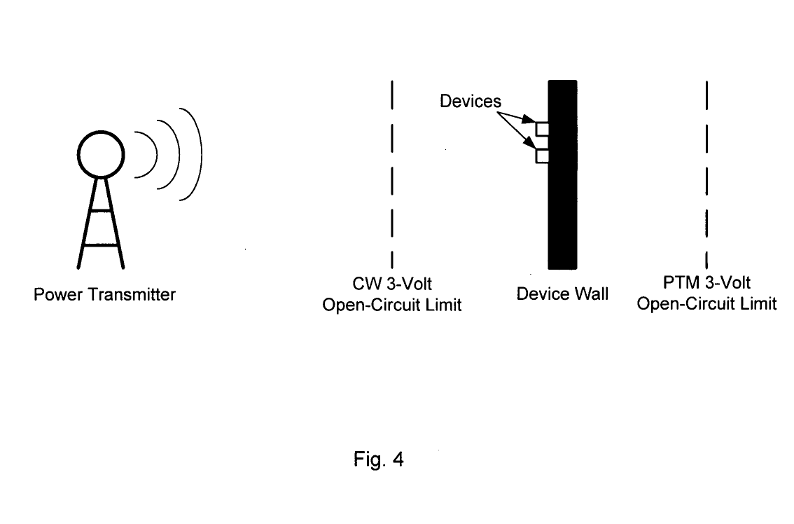

As an example, assume there are some devices that have 3-volt (V) batteries that need to be recharged on a constant basis, but cannot be moved and the batteries cannot be removed. The option is given of either using a CW power transmission system, or a PTM power transmission system 10 to supply RF power to a circuit designed to receive RF power and charge the batteries of the devices. The devices are fixed on a wall that is 20 feet away from where the power transmitter 12 needs to be for either power transmission system 10. The only requirement given is that of average output power be 5 watts (W). This limit may be specified due to regulatory agencies or due to health concerns from RF exposure. For the CW system, in which the power transmitter outputs a constant 5 watts of RF power, a circuit designed to receive RF power might have an open circuit voltage of 3 volts when it is within 10 feet of the power transmitter. This means only devices that are within 10 feet of the power transmitter 12 will be able to charge their batteries, and therefore this system 10 would not work for this example. The other option given is the PTM system 10, which correlates to making the power transmitter 12 have a higher peak output power, but only be on for a fraction of the time the CW power transmitter is on. In this case, it is chosen to output 10 times the power. The PTM system 10 outputs 50 watts peak power, and using equation 1, it can be determined that the power transmitter 12 should only be outputting RF power for one-tenth the time of the CW system. Therefore, we can set up a PTM power transmission system 10 that outputs 50 watts for 1-second out of a 10-second period and is off for the other 9 seconds. According to equation 1, the PTM power transmitter 12 is averaging 5 watts of RF power output, the same as the CW system. However, the 50-watt pulses from the PTM system 10 are allowing the circuits designed for receiving RF power to produce an open-circuit voltage of 3 volts during the pulses at approximately 30 feet meaning a charge storage device at 3V such as, but not limited to, a battery can be charged or recharged. It is easily seen that the clear choice for implementing this charging solution would be a PTM system 10 due to the increase in distance or range compared to a CW system. This example can be seen in FIG. 4.

The open-circuit voltage of the PTM system 10 can be approximated using the following analysis.

The open-circuit voltage for a CW system, V_{oc-CW}, can be calculated easily by one skilled in the art by multiplying the electric field strength, E, of the incoming wave by the effective height, hₑ, of the antenna 18 as shown in the following equation.
V_{oc-cw}=E·hₑ (2)

The electric field strength can be related to the transmitted power by the following equation.

$$E = \sqrt{\frac{{P}_{T} {G}_{T} η}{4 π {r}^{2}}} \qquad ( 3 )$$

where P_{T} is the transmitted power, G_{T} is the gain of the transmitter 12, η is the impedance of free space, and r is the distance between the RF power transmitter 12 and the RF power harvesting antenna 18.

Combining the previous two equations shows that the open-circuit voltage at a given point in space is directly proportional to the square-root of the transmitted power as shown in the following equation.

$${V}_{oc - CW} = \sqrt{\frac{{P}_{T} {G}_{T} η}{4 π {r}^{2}}} \cdot {h}_{e} \qquad ( 4 )$$

Therefore, the open-circuit voltage of a PTM system 10, V_{oc-PTM}, can be related to the open-circuit voltage of a CW system by the square-root of X, where X is shown in FIG. 1 as the amplitude increase of the pulse over the CW power level. This equation is shown below.

$$\begin{matrix}\frac{{V}_{oc - PTM} = \sqrt{\frac{{XP}_{T} {G}_{T} η}{4 π {r}^{2}}} \cdot {h}_{e}}{{V}_{oc - CW} = \sqrt{\frac{{P}_{T} {G}_{T} η}{4 π {r}^{2}}} \cdot {h}_{e}} \to \frac{{V}_{oc - PTM}}{{V}_{oc - CW}} = \sqrt{X} & ( 5 ) \\ {V}_{oc - PTM} = \sqrt{X} \cdot {V}_{oc - CW} & ( 6 )\end{matrix}$$

This analysis was tested using a circuit designed for receiving RF power and converting the RF power to DC power. The circuit was matched to a 50-ohm input and the circuit was designed to not have a load 16. The voltage being measured was the DC open-circuit voltage. For a CW power transmission system with a given input power level being applied to the circuit, the open-circuit voltage was read to be 2.275 volts. This is not enough voltage to charge the 3-volt batteries from the previous example. Switching to the PTM power transmission system 10 with a peak pulse power double that of the CW system, but on for half the time, therefore averaging the power to that of the CW system, the open-circuit voltage during the pulse was 3.3 volts. The circuit was easily getting enough power to charge the batteries from the previous example. From the analysis above, the open-circuit voltage of the PTM system 10 during the pulse divided by the open-circuit voltage of the CW system should be equal to the square-root of the pulse multiplier, which in this case is 2. Therefore, 3.3 volts divided by 2.275 is equal to 1.45, which is essentially equal to the square-root of 2, or 1.414. In summary, using a PTM power transmission system 10 allows for recharging of power storage devices at a lower average power than a CW power transmission system.

In a fashion similar to using PTM to increase the distance at which a given power level, or open-circuit voltage, can be received by a circuit designed for receiving RF power, a PTM system 10 can be used to penetrate an area that a CW system cannot. As one example, there are 2 rooms side-by-side and separated by a thick wall. A CW power transmission system set up in room 1 cannot power any circuits designed for receiving RF power in room 2 at the current average output power that the system 10 is designed for because the wall between the rooms attenuate the power signal being transmitted. Instead of increasing the average output power of the CW system to get coverage in room 2, a PTM power transmission system 10 could be implemented in room 1. This PTM system 10 would allow for the same average power to be output from the system 10, but, because of the higher peak output power of the pulses, the circuits designed for receiving RF power in room 2 are now able to receive power at useable voltage levels from the PTM system 10. It should be noted that the useable voltage level may be defined as, but not limited to, the minimum voltage required to operate a circuit in direct powering applications and/or as the battery or storage element voltage for power storage device recharging. It should also be noted that devices that do not contain a power storage device, such as but not limited to a battery or super-capacitor, are considered to be directly powered.

A similar example is that of powering devices that are contained, implanted, or immersed within a human, an animal, other living things, or other attenuating mediums. Many medical devices are becoming smaller and can be safely implanted into the bodies of humans or animals. However, these medical devices still need power, whether it is battery or some form of wireless power transmission. Wireless power transmission is an ideal solution, because devices with batteries will eventually have to have the batteries replaced. However, like the example above with 2 rooms separated by the attenuating wall, the body has an attenuating effect on the transmitted power signal also. Using a CW power transmission system would require a high average output power from the transmitter to receive a useable voltage level to directly power the RF power-harvesting device or to charge or recharge a power storage device after the signal is attenuated. This is dangerous to the human or animal involved because high average power levels of RF energy will generate heat in the body of the human or animal as the RF power enters the body and is attenuated or dissipated, which will cause cells and tissue to be heated, altered, damaged, or killed. Using a PTM power transmission system 10 eliminates this problem by allowing much lower average power levels of RF energy to enter the body, while at the same time, penetrating the attenuating body to deliver RF power to the circuits designed for receiving RF power at useable voltage levels.

Another benefit of the PTM is the increase in the received voltage for a given transmitter 12 power level. As an example, a security sensor 46 may require 20 micro-Watts (uW) of power to operate with a minimum useable voltage of 1.8 volts. The sensor 46 may be required to work at a distance of 30 feet. The limiting factor in this example will most likely be the voltage required by the sensor 46 rather than the amount of power needed. More specifically, the sensor 46 may receive 20 uW of power at distance of 30 feet, however, the voltage may be significantly lower than 1.8 volts. To compensate for the low voltage level at the receiver 32, a continuous-wave transmitter must transmit more power resulting in more than 20 uW at 30 feet in order for the receiver 32 to supply 1.8 volts to the sensor 46. However, in a PTM system 10, the amplitude of the pulse or peak output power can be set by examining the minimum voltage needed by the sensor 46 and the duty cycle of the pulsing waveform can be set by the amount of power required by the sensor 46. So, for the example given, a CW system may give 500 uW at a distance of 30 feet in order to get 1.8 volts. The PTM system 10 would use a peak power level for the pulses that was the same as the CW system in order to give the sensor 46 1.8 volts. However, the PTM system 10 would use a duty cycle of four percent (20 uW/500 uW) to give the sensor 46 only the 20 uW that the sensor 46 needs. The resulting PTM system 10 would meet the requirements of the sensor 46 by using 96% less average transmitted power than the power transmitted in the CW system.

It should be noted that the invention works at any frequency and with any antenna(s) 18, such as, but not limited to, dipole, dipole-array, monopole, patch, Yagi, helical, horn, dish, corner-reflector, panel, or any other antenna 18. These antennas 18 can be designed to have any polarization, such as, but not limited to, linear, horizontal, vertical, circular, elliptical, dual, dual-circular, dual elliptical, or any other polarization. This method also works with multiple antennas 18, of any type listed above and using any polarization listed above, connected to a single transmitter 12.

Tests have been performed in the FM radio band at 98 MHz. The tests were performed in a shielded room to avoid interference with radio service. The duty cycle of the pulse was varied from 100 percent (CW) to 1 percent with a constant period of 100 milliseconds (ms) and 1 second, which are shown in Table 2 and Table 3, respectively. The amplitude of the pulse was adjusted to obtain an average power of 1 milliwatt (mW). The tables show the various duty cycles tested, and the DC voltage and power converted by the receiver 32. The receiving circuit is illustrated in FIG. 2. As can be seen from Table 3, the received DC voltage increases by a factor of approximately 10, and the power increases by a factor of approximately 100 by changing the duty cycle from 100% to 1%.

TABLE 2
Experimental Results at 98 MHz, Period of 100 m

| | | | | Received | |
|---|---|---|---|---|---|
| | Pulse | Peak | Average | DC | Received |
| Duty | Width | Transmit | Transmit | Voltage | DC Power |
| Cycle | (ms) | Power (mW) | Power (mW) | (V) | (μW) |
| 100.0% | 100.0 | 1.00 | 1.00 | 0.31 | 0.291 |
| 50.0% | 50.0 | 2.00 | 1.00 | 0.28 | 0.238 |
| 40.0% | 40.0 | 2.50 | 1.00 | 0.46 | 0.641 |
| 20.0% | 20.0 | 5.00 | 1.00 | 0.74 | 1.659 |
| 16.0% | 16.0 | 6.25 | 1.00 | 0.83 | 2.088 |
| 10.0% | 10.0 | 10.0 | 1.00 | 1.09 | 3.600 |
| 8.00% | 8.00 | 12.5 | 1.00 | 1.25 | 4.735 |
| 5.00% | 5.00 | 20.0 | 1.00 | 1.55 | 7.280 |
| 4.00% | 4.00 | 25.0 | 1.00 | 1.72 | 8.965 |
| 2.00% | 2.00 | 50.0 | 1.00 | 2.4 | 17.455 |
| 1.60% | 1.60 | 62.5 | 1.00 | 2.6 | 20.485 |
| 1.25% | 1.25 | 80.0 | 1.00 | 2.71 | 22.255 |
| 1.00% | 1.00 | 100.0 | 1.00 | 2.54 | 19.550 |

TABLE 3
Experimental Results at 98 MHz, Period of 1000 ms

| | | | | Received | |
|---|---|---|---|---|---|
| | Pulse | Peak | Average | DC | Received |
| Duty | Width | Transmit | Transmit | Voltage | DC Power |
| Cycle | (ms) | Power (mW) | Power (mW) | (V) | (μW) |
| 100.0% | 1000.0 | 1.00 | 1.00 | 0.29 | 0.255 |
| 50.0% | 500.0 | 2.00 | 1.00 | 0.41 | 0.509 |
| 40.0% | 400.0 | 2.50 | 1.00 | 0.52 | 0.819 |
| 20.0% | 200.0 | 5.00 | 1.00 | 0.74 | 1.659 |
| 16.0% | 160.0 | 6.25 | 1.00 | 0.85 | 2.189 |
| 10.0% | 100.0 | 10.0 | 1.00 | 1.12 | 3.801 |
| 8.00% | 80.00 | 12.5 | 1.00 | 1.26 | 4.811 |
| 5.00% | 50.00 | 20.0 | 1.00 | 1.6 | 7.758 |
| 4.00% | 40.00 | 25.0 | 1.00 | 1.75 | 9.280 |
| 2.00% | 20.00 | 50.0 | 1.00 | 2.31 | 16.170 |
| 1.60% | 16.00 | 62.5 | 1.00 | 2.61 | 20.643 |
| 1.25% | 12.50 | 80.0 | 1.00 | 2.83 | 24.269 |
| 1.00% | 10.00 | 100.0 | 1.00 | 3.03 | 27.821 |

Another example of frequency bands that many be useful when implementing this method includes the Industrial, Scientific, and Medical Band (ISM). This band was established to regulate industrial, scientific, and medical equipment that emits electromagnetic energy on frequencies within the radio frequency spectrum in order to prevent harmful interference to authorized radio communication services. These bands include the following: 6.78 MHz ±15 KHz, 13.56 MHz ±7 KHz, 27.12 MHz ±163 KHz, 40.68 MHz ±20 KHz, 915 MHz ±13 MHz, 2450 MHz ±50 MHz, 5800 MHz ±75 MHz, 24125 MHz 1125 MHz, 61.25 GHz +250 MHz, 122.5 GHz ±500 MHz, and 245 GHz ±1 GHz.

The Pulsed Transmission System 10 has numerous advantages. Some of them are listed below.
1. The overall efficiency of the system 10 is increased by an increase in the rectifier 28 efficiency. To help illustrate this statement, the data in Table 3 will be examine. The CW system (100% duty cycle) was able to receive and convert 0.255 uW of power while the 1.00% PTM captured 27.821 uW. This is an increase in efficiency by over 10,000%.
2. Larger output voltages can be obtained when comparing the average to a CW system. This is caused by the increase in rectifier 28 efficiency. It is also a factor of the large power pulse, which produces a large voltage pulse at the in input to the filter 30 in FIG. 2. The large voltage pulse will be filtered and provide a larger voltage assuming the load 16 is large.
3. The increase in system 10 efficiency allows the use of less average transmitted power to obtain the same received DC power. This leads to the following advantages.
   a. The human safety distance from the transmitter 12 is reduced due to the reduction in the average transmitted power. (Human Safety Distance is a term used to describe how far a person must be from a transmitting source to ensure they are not exposed to RF field strengths higher than that allowed by the FCC's human safety regulations. As an example, the permitted field strength for general population exposure at 915 MHz is 0.61 mW/cm².)
   b. Less average transmitter 12 power allows operation in an increasing number of bands including those that do not require a license such as the Industrial, Scientific, and Medical (ISM) bands.
   c. For licensed bands, the decrease in the average transmitter 12 power translated to a decrease in the amount of licensed power.
4. Using a PTM power transmission system 10 allows for recharging of power storage devices at a lower average output power than a CW power transmission system.

5. Allows not only for greater distances of higher power levels and DC open-circuit voltages, but can penetrate objects that attenuate RF energy to deliver power without increasing the average output power of the transmitter 12 in the system 10.

There are current patents that bear a resemblance to the method described, however, their fundamental approach to the problem is for a different purpose. U.S. Pat. No. 6,664,770 describes a system that uses a pulse modulated carrier frequency to power a remote device that contains a DC to DC (DC-DC) converter. A DC-DC converter is used to transform the level of the input DC voltage up or down depending on the topology chosen. In this case, a boost converter is used to increase the input voltage. The device derives its power from the incoming field and also uses the modulation contained within the signal to switch a transistor (fundamental component in a DC-DC converter) for the purpose of increasing the received voltage. The waveform described within this document will have similar characteristics to the one described in the referenced patent. The system 10 described here has numerous differences. The proposed receiver 32 does not contain a DC-DC converter. In fact, this method was developed for the purpose of increasing the received DC voltage without the need for a DC-DC converter. Also, the modulation contain within the proposed signal is not intended for use as a clock to drive a switching transistor. Its purpose is to allow the use of a large peak power to increase the efficiency of the rectifying circuit, which in turn increases the receiver 32 output voltage without a need for a DC-DC converter or derivation of a clock from the incoming pulsed signal.

As previously stated, the pulsed waveform is not intended for use as a clock signal. If a DC-DC converter 42 is needed in the receiving circuit because the pulsed waveform has not solely produced a large enough voltage increase (by the increase in efficiency), the DC-DC converter 42 will be implemented using an on-board clock generated using the pure DC output of the rectifier 28. The generation of the clock in the receiver 32 proves to be more efficient than including extra circuitry to derive the clock from the incoming pulsing waveform, hence providing a greater receiver 32 efficiency than the referenced patent. FIG. 5 shows how this system 10 would be implemented.

There have recently been successful tests performed by Lucent Digital Radio, Inc., a venture of Lucent Technologies and Pequot Capital Management, Inc., to integrate digital radio service into the existing analog radio signals without interactions with the current service. With this being said, it is possible to integrate a power transmission signal, such as the one described in this document, into existing RF facilities (Radio, TV, Cellular, etc.) if it is found to be advantageous. This would allow the stations to provide content along with power to devices within a specified area.

It should be noted that pulsing the output power from the transmitter (OOK) also produces a pulsed output from the rectifier in the receiver circuit. As an example, if the transmitted power is pulsed at 60 Hz with a fifty percent duty cycle, the ON time will be approximately 8.3 ms and the OFF time will also be approximately 8.3 ms. This means that the rectifier will supply no current to the load during the OFF period. It may, therefore, be necessary to add a storage element to the output of the rectifier to ensure that the output voltage or current does not drop by more than a predetermined value during the OFF period of the pulse. As an example, a storage capacitor could be included at the output of the rectifier. The storage capacitor may also be viewed as a filter used to filter out the frequency of the pulsing power. This filter capacitor should not be confused with the filter capacitor used within the rectifier to remove the carrier from the DC output. In most cases, the pulsing frequency and the carrier frequency will be greatly different in frequency requiring different filtering components. As an example, the output of the rectifier may include a 100 pF high-Q capacitor in order to remove a 915 MHz carrier frequency with minimal loss. The pulsing frequency may be 60 Hz, which requires a vastly larger capacitor to store energy (or filter the pulse) during the 8.3 ms OFF period than that used within the rectifier.

Pulse Transmission Method—2

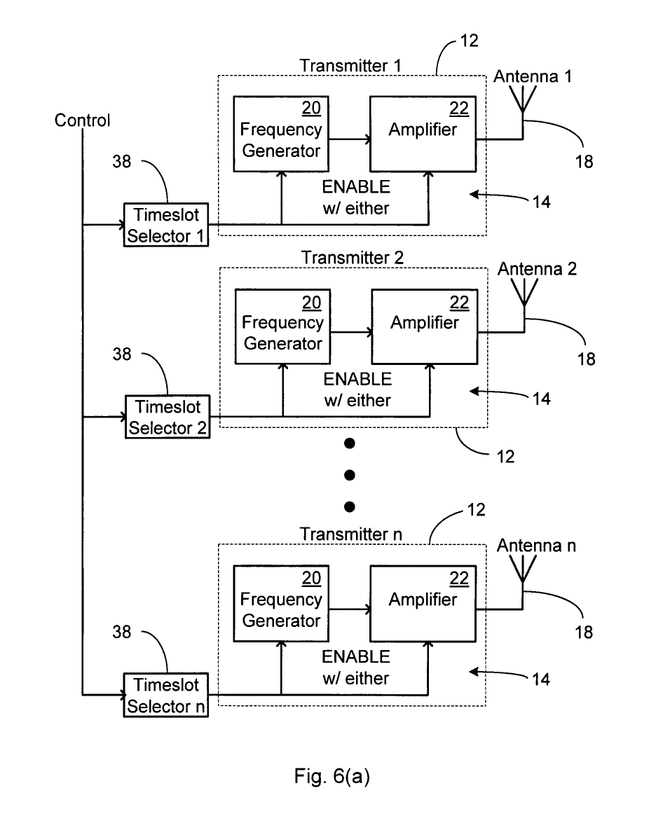

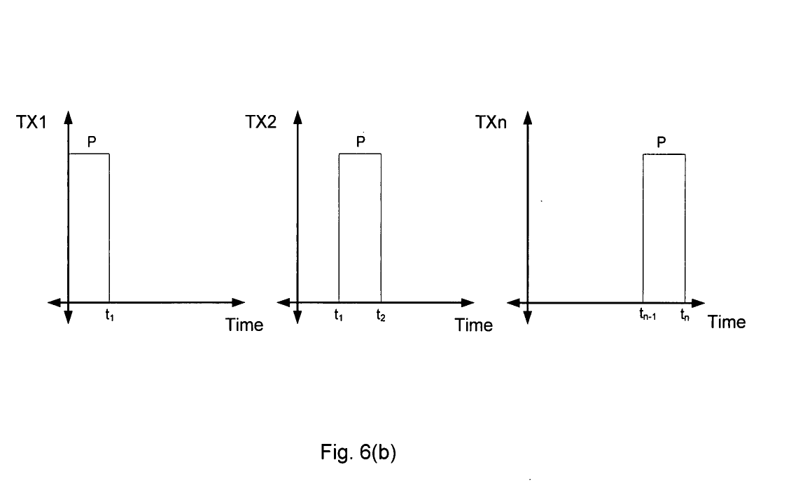

When multiple transmitters 12 are used, the pulse transmission method provides a solution to another common problem, phase cancellation. This is caused when two (or more) waves interact with one another. If one wave becomes 180 degrees out of phase with respect to the other, the opposite phases will cancel and little or no power will be available and that area will be a null. The pulse transmission method alleviates this problem due to its non-CW characteristics. This allows multiple transmitters 12 to be used at the same time without cancellation by assigning each transmitter 12 a timeslot so that only one pulse is active at a given time. For a low number of transmitters 12, timeslots may not be needed due to the low probability of pulse collisions. The system 10 hardware is shown in FIG. 6a while the signals are shown in FIG. 6b. The control signal is used to activate each transmitter 12 for its assigned timeslot. The timeslot selector 38 either enables or disables the transmitting block by providing a signal to the frequency generator 20 and/or the amplifier 22 and can be implemented in numerous ways including, but not limited to, a microcontroller 48.

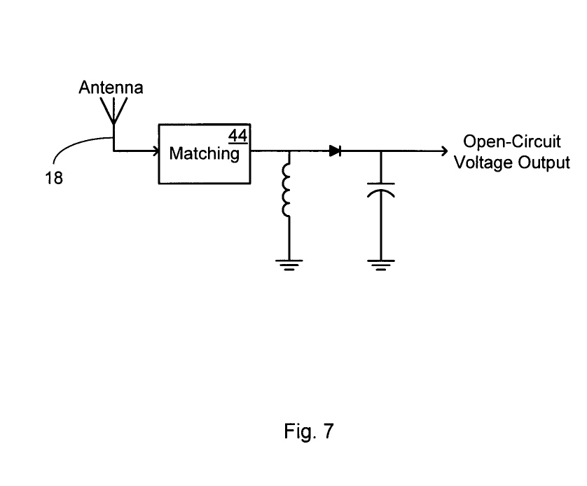

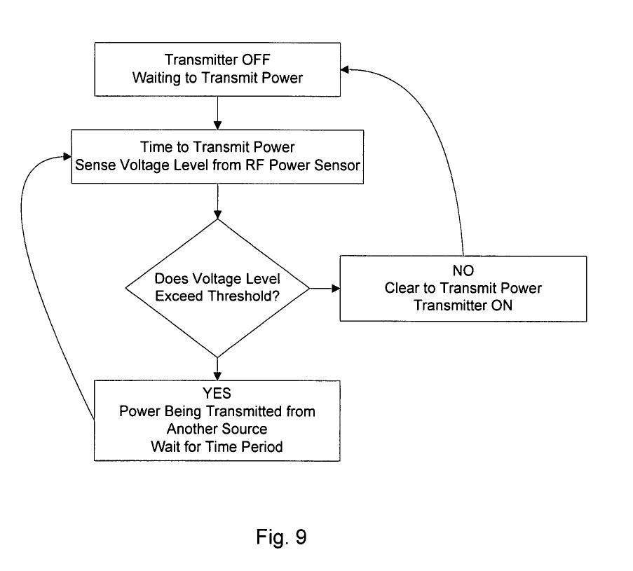

The timeslot selector 38 could also be wireless in design, allowing each transmitter 12 to operate independently. The timeslot selector 38 may be implemented in numerous ways including, but not limited to, adding an RF power-sensing device, such as but not limited to the one shown in FIG. 7, to the transmitter 12 that can sense when another RF power transmitter 12 near the RF power transmitter 12 is transmitting RF power. The RF power sensor 46 may be implemented as an RF energy harvesting circuit such as but not limited to the one shown in FIG. 7, which may contain at least one antenna 18, rectifier 28 or RF to DC converter 36, and/or filter 30. If the timeslot selector 38 senses RF power already being transmitted from another RF power transmitter 12 (i.e., an output from the power sensor is above a threshold, such as a voltage threshold), the RF power transmitter 12 waits for a designated time period such as but not limited to one pulse duration, senses for RF power again, and then transmits RF power when no other RF power is being transmitted (i.e., the output from the power sensor is below a threshold). The control of the RF power transmitter 12 may be performed by, but not limited to, a microcontroller 48 in communication with the RF power sensor 46 as shown in FIG. 8 where the output from the microcontroller 48 may be used to control the RF power transmitter 12 by use of an enable or gain control 26 line which are shown in numerous figures presented herein. The microcontroller 48 may contain an analog to digital converter 36, a voltage comparator, or a standard input pin for sensing the presence of an RF power pulse from another RF power transmitter 12. The microprocessor may determine by the status of the analog to digital converter 36, voltage comparator, or a standard input pin whether to transmit an RF power pulse or whether to wait a predetermined time period before transmitting the RF power pulse. FIG. 9 shows an algorithm that may be used by the microcontroller 48 to determine the timing of the transmitted RF power pulse.

In certain applications the timeslot selector 38 may be an RF power sensor 46, such as but not limited to the one shown in FIG. 7, with the purpose of sensing the RF power available from the other RF power transmitters 12 and used to adjust the output of the corresponding RF power transmitter 12 in order to insure that the equivalent field strength caused by any pulsing overlap, if any, does not exceed regulatory limits. The equivalent field strength of other RF power transmitters 12 may be determined by measuring the voltage, current, and/or power level from the output of the RF power-sensing device by use of an analog to digital converter 36, voltage comparator, or other application specific voltage, current, and/or power level sensing circuit in communication with a controller or directly connected to the enable or gain control 26 line which are shown in numerous figures presented herein. An example of this method can be seen in FIG. 10.

It may be advantageous in certain applications to have overlap in the timeslots, which could be controlled by the timeslot selector 38 with the amplitude and timeslot controlled with an RF power sensor 46. The RF power sensor 46 may be implemented as an RF energy harvesting circuit such as but not limited to the one shown in FIG. 7, which may contain at least one antenna 18, rectifier 28 or RF to DC converter 36, and/or filter 30. The output of the RF power sensor 46 may be connected to a device such as, but not limited to, a microcontroller 48, analog to digital converter 36, a voltage level detecting circuit for the purpose of determining whether an RF power transmitting is currently transmitting an RF power pulse and the amplitude of the corresponding pulse, or may be directly connected to the enable or gain control 26 lines on the RF amplifier 22 in the RF power pulsing transmitter 12 or pulse generator 14, which are shown in numerous figures presented herein.

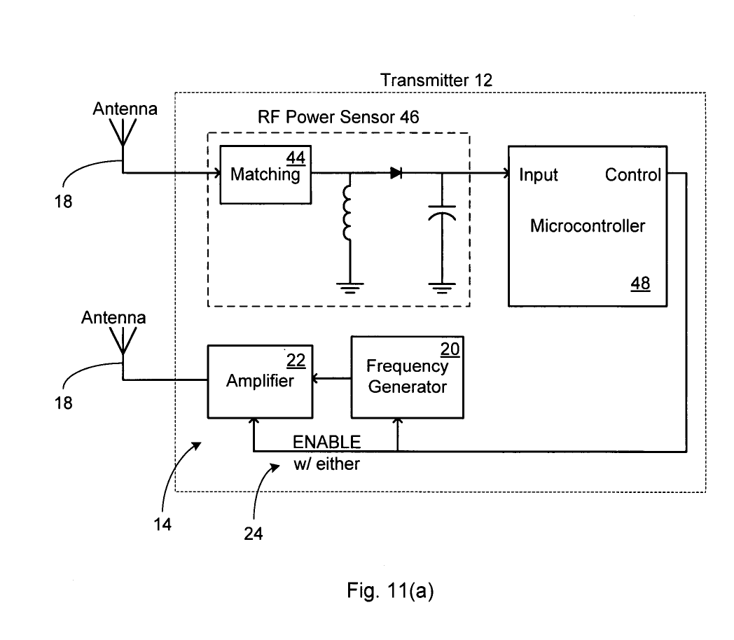

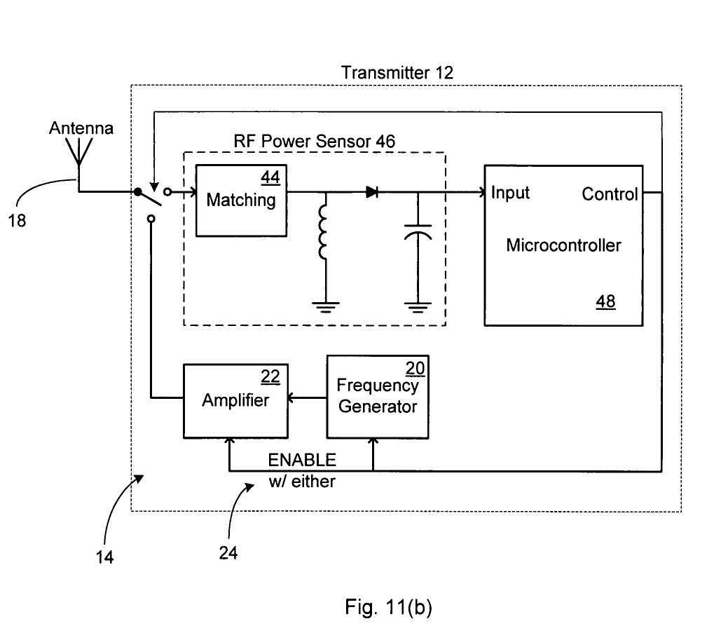

It should be noted that the RF power sensor 46 may use its own antenna 18 or may share an antenna 18 with the RF power transmitter 12 as shown in FIG. 11 a) and b), respectively. The antenna 18 switching control may be performed using the same microcontroller 48 in communication with the RF power sensor 46 or the switch may be implement with a circulator or directional coupler. It may be advantageous in certain applications to use the enable or pulse generator 14 to control the operation of the antenna 18 switch to ensure that the output of the RF amplifier 22 is never active while the RF power sensor 46 is connected to the antenna 18.

Pulse Transmission Method—3

A somewhat easy way to accomplish the multiple transmitter 12, multiple frequency method of pulse transmission is to fabricate each transmitter 12 using the exact same components and design. Anyone skilled in the art knows that all components have tolerances based on slight manufacturing and temperature changes from component to component. Therefore, the fabrication of more than one identical transmitter 12 will result in these transmitters 12 having slight variations in frequency being generated by the frequency generator 20 and amplitude of the signal being outputted. These variations could result from the components being manufactured differently or they could be the result of one transmitter 12 being placed in a position where it gets slightly warmer than the others. These slight differences between identical transmitters 12 will essentially place identical transmitters 12 on slightly different frequencies or channels to produce the result shown in FIG. 12. The slight difference in frequency insures that at a given point in space, the signals from multiple transmitters 12 will constantly be drifting in and out of phase meaning at a certain times they will destructively interfere while at a later time they will constructively interfere meaning the average received power will be the same as if there was no interference.

Pulse Transmission Method—Alternatives

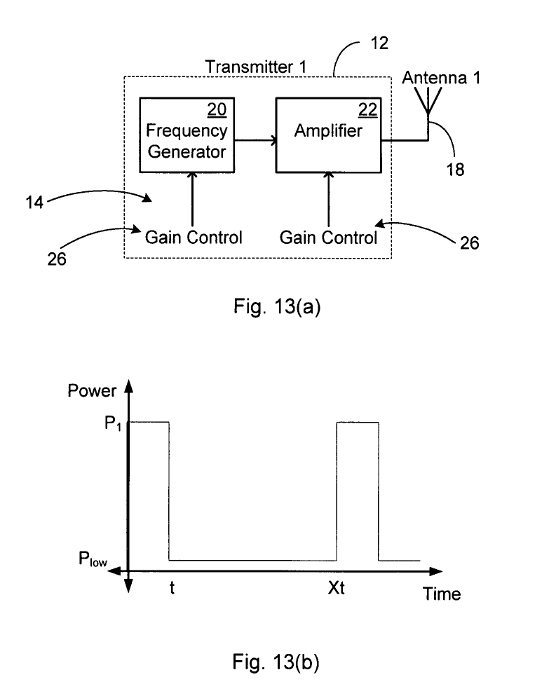

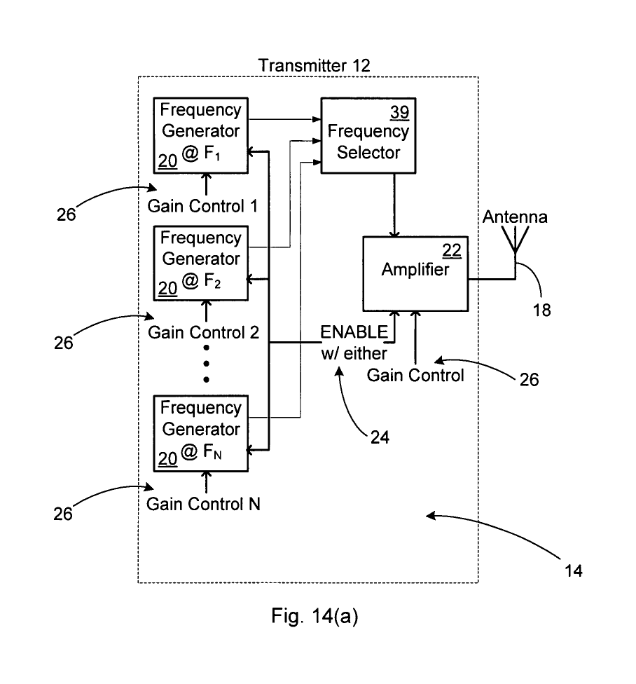

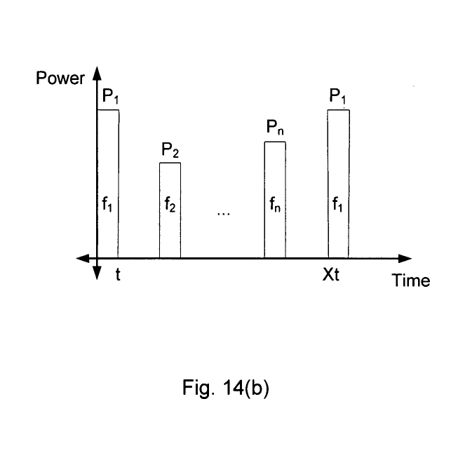

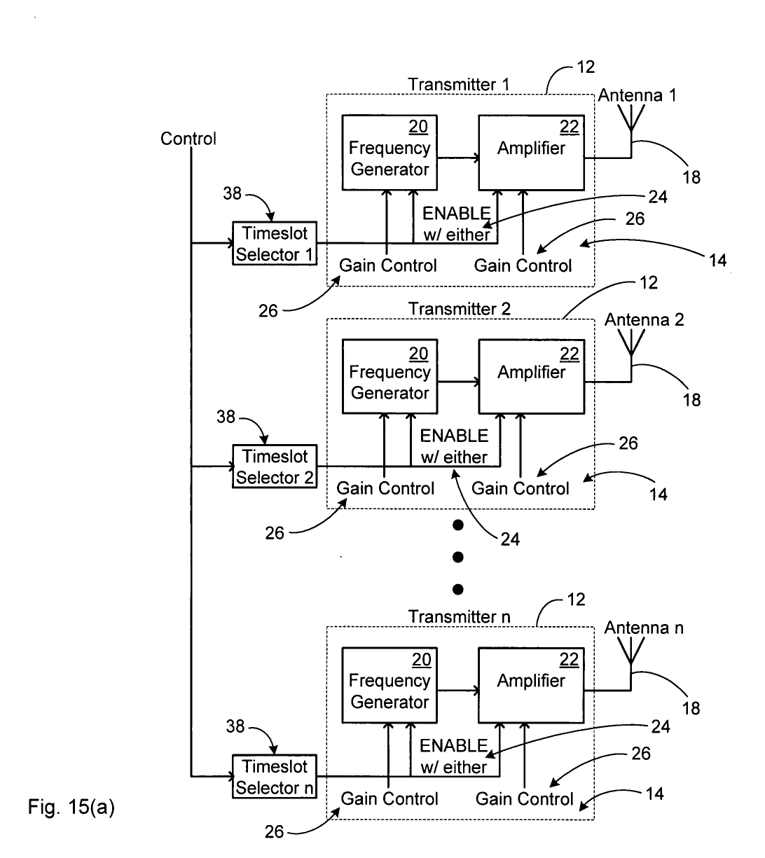

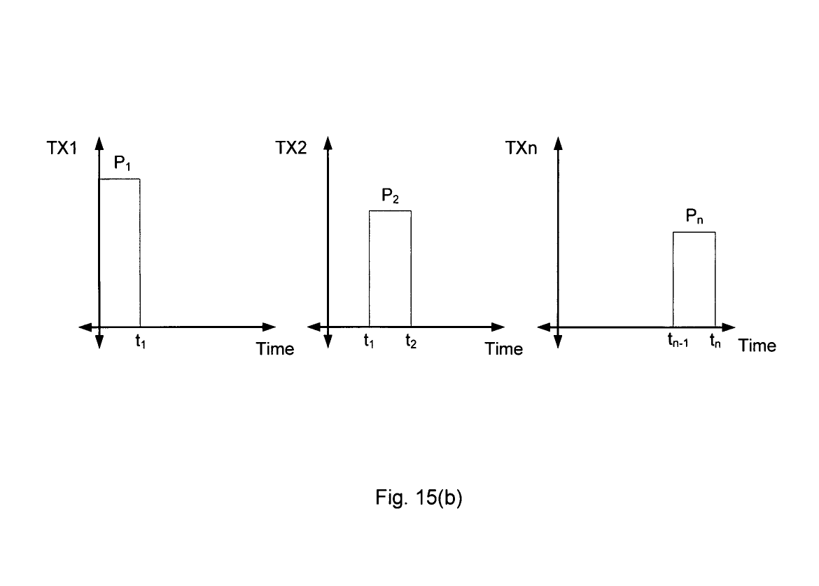

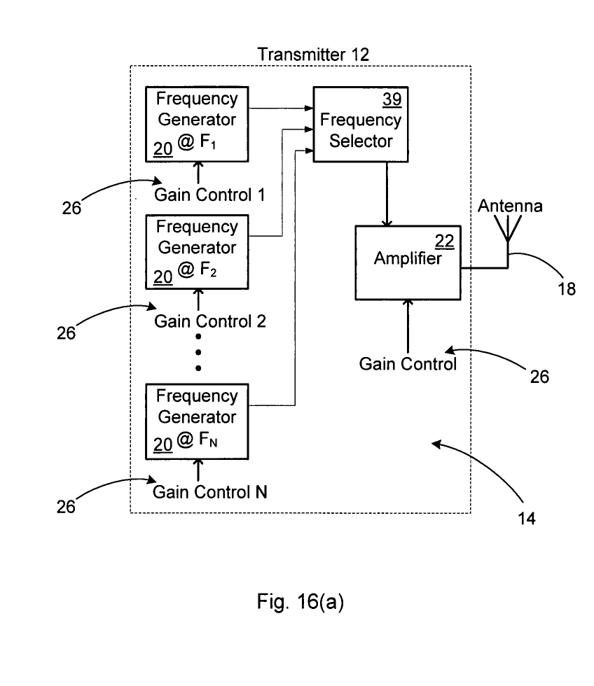

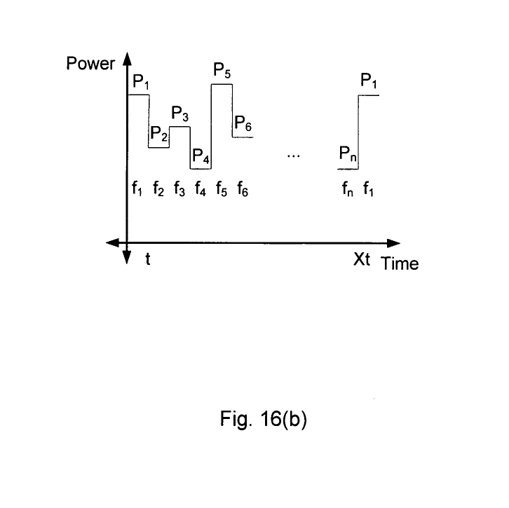

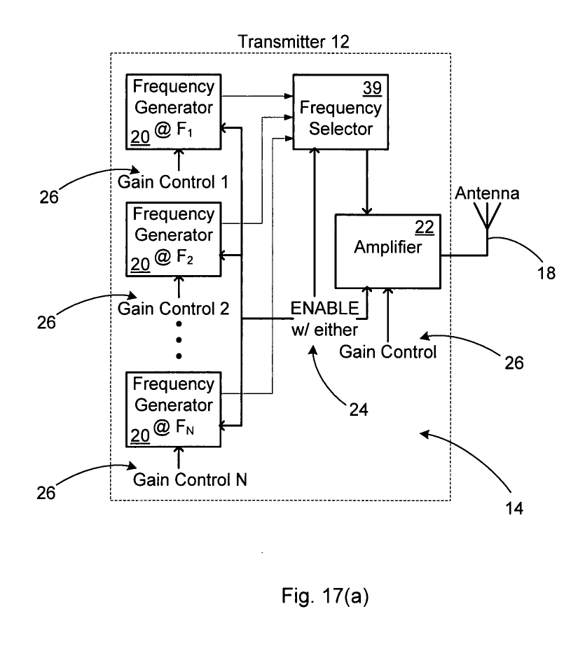

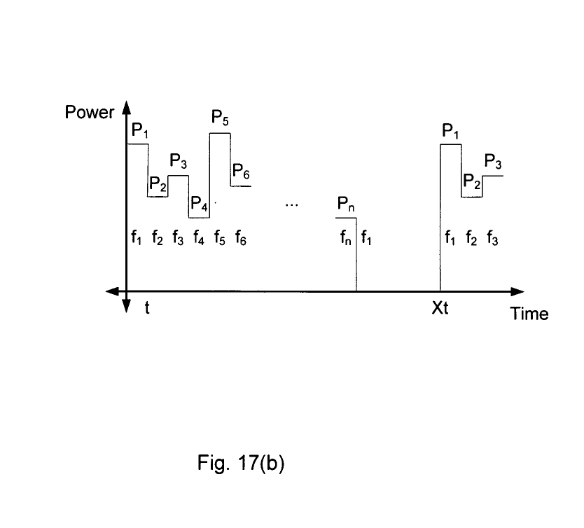

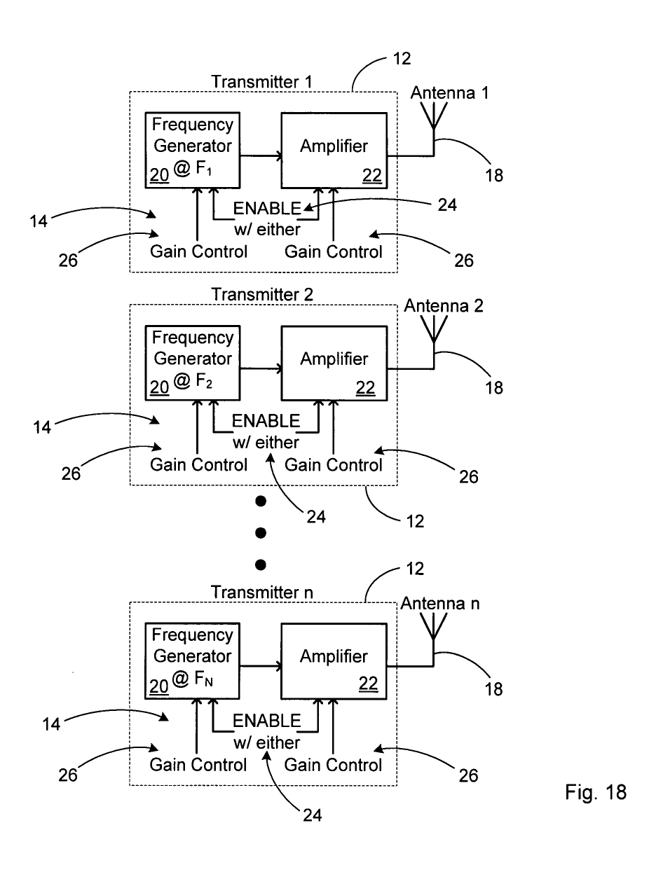

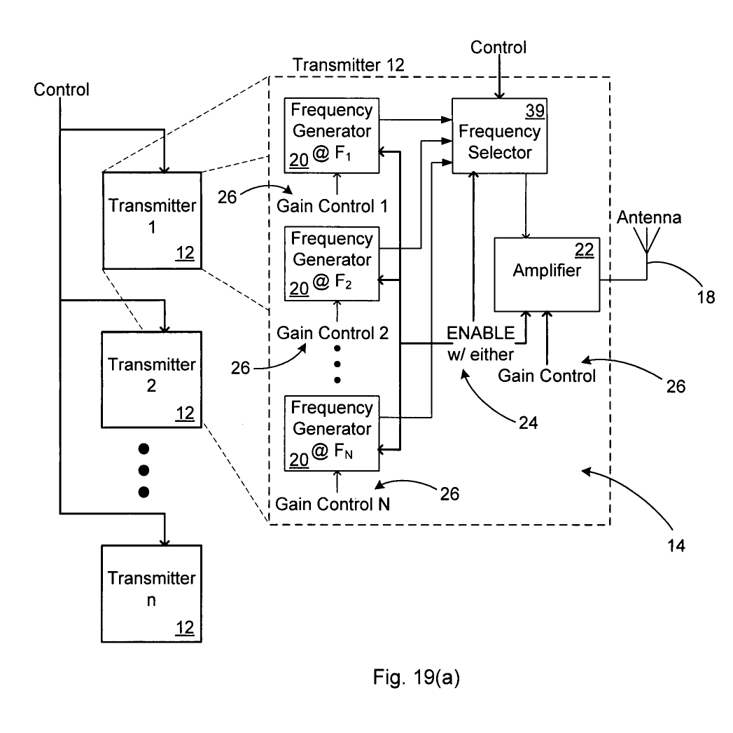

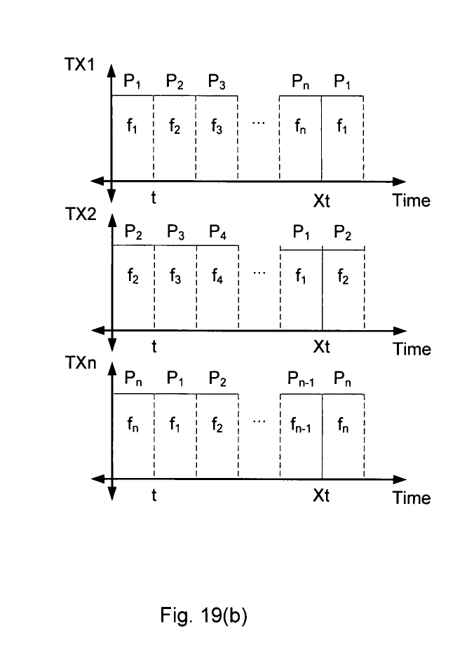

There are numerous extensions of the three methods previously described in this document. These include, but are not limited to, the following.
Alt 1. Alternative of Technique 1—The carrier does not fully go to zero, yet keeps a finite value for supplying low power states such as the device's sleep mode. This method is shown by the block diagram in FIG. 13a and the pulsing waveform in FIG. 13b. The blocks have been described in Table 1. The Enable signal line has been replaced with a Gain control 26 line, which is used to adjust the level of the output signal. The Gain control 26 line can be implemented in numerous ways. On the Frequency generator 20, the Gain control 26 line can be a serial input to a Phase-Locked Loop (PLL) used to program internal registers that have numerous responsibilities including adjusting the output power of the device. The Gain control 26 on the Amplifier 22 can simply be a resistive divider used to adjust the gate voltage on the amplifier 22, which in turn changes the amplifier 22 gain. It should be noted that the Gain control 26 line can adjust the amplifier 22 to have both positive and negative gain. This applies to all references to the Gain control 26 line within this document.
Alt 2. Alternative of Technique 1—The transmitter 12 may pulse different frequencies sequentially to reduce the average power for that channel. Each frequency and/or pulse may have different amplitudes. In FIG. 14a, each Frequency generator 20 produces a different frequency. All of these frequencies are fed into the Frequency selector 39 which determines and routes the correct frequency to the amplifier 22. This block could be implemented with a microcontroller 48 and a coaxial switch. The microcontroller 48 would be programmed with an algorithm that would activate the correct coaxial switch in the appropriate timeslot to produce the waveform in FIG. 14b. Multiple frequency generators 20 can be implemented using a single component that can change the frequency that it outputs, such as, but not limited to, a PLL, which could eliminate the need for a frequency selector 39. This can be applied to all methods where multiple frequency generators 20 are needed.
Alt 3. Alternative of Technique 2—Each transmitter 12 and/or frequency may have different amplitudes. The block diagram in FIG. 15a adds a Gain control 26 to produce various output signal levels shown in FIG. 15b.
Alt 4. Alternative of Technique 3—A single transmitter 12 could be used to transmit all the channel frequencies sequentially to eliminate the need for multiple transmitting units. This would resemble a CW system employing frequency hopping although no data will be sent, and the purpose will be for power harvesting. Each channel may have different amplitude. All of these frequencies are fed into the Frequency selector 39 which determines and routes the correct frequency to the amplifier 22. This block could be implemented with a microcontroller 48 and a coaxial switch. The Enable has been removed due to the continuous nature of the output signal. A block diagram for this method can be seen in FIG. 16a while the pulsing waveform is shown in FIG. 16b.
Alt 5. Alternative of Technique 4—This waveform (multiple frequencies) could be pulsed as described in Method 1. The single frequency, constant amplitude pulse in Method 1 has been replaced with a pulse containing timeslots. Each timeslot can have a different frequency and amplitude. The Enable line has been added to allow the system 10 to turn the output on and off for pulsing. The Gain control 26 line, Enable line and Frequency selector 39 function as previously described. A block diagram for this method can be seen in FIG. 17a while the pulsing waveform is shown in FIG. 17b.
Alt 6. Alternative of Technique 3—Each transmitter 12 and/or frequency may have different amplitudes. A Gain control 26 line has been added to allow the output signal level to be varied. A block diagram for this method can be seen in FIG. 18.
Alt 7. Alternative of Technique 4—Multiple transmitters 12 could transmit all the channel frequencies sequentially with each channel occurring at a different transmitter 12 in a different timeslot. In this method, a Control signal is used to synchronize multiple transmitters 12 at multiple frequencies in a way that each transmitter 12 is always on a different channel with respect to the other transmitters 12. This system 10 also includes a gain control 26 to change the level of the output of each transmitter 12. The Control line could be driven by a microcontroller 48 that has been programmed with an algorithm for the purpose of assigning each transmitter 12 a different frequency for the current timeslot. In the next timeslot, the microcontroller 48 would change the frequency assignments while assuring that all transmitters 12 are operating on separate channels. The Gain control 26 of each transmitter 12 could be controlled by the same master microcontroller 48 or by a microcontroller 48 local to that transmitter 12. The Enable Line allows a transmitter 12 to disable itself if found to be beneficial. A block diagram for this method can be seen in FIG. 19a while the pulsing waveform is shown in FIG. 19b.

Additional Notes

It should be noted that the pulse widths and periods of sequential pulses may vary with time. Also, the duration of each timeslot may be different and may vary with time.

If the device being remotely powered is a wireless sensor 46 or other device that reports data back to a base station at intervals, a concern is that the RF power signal being used to power the device or charge a power storage device, whether CW or PTM, could interfere with the wireless device transmitting its data. In the PTM case, the wireless device could be designed to sense when a pulse is incoming, and transmit its data (using a separate or shared antenna with the power system) during the off period of the pulse. This would effectively eliminate any inference with a wireless device that transmits its data periodically. This is another advantage that the PTM has over a CW system. The CW system will always be on, and therefore the chance for interference will be much greater.

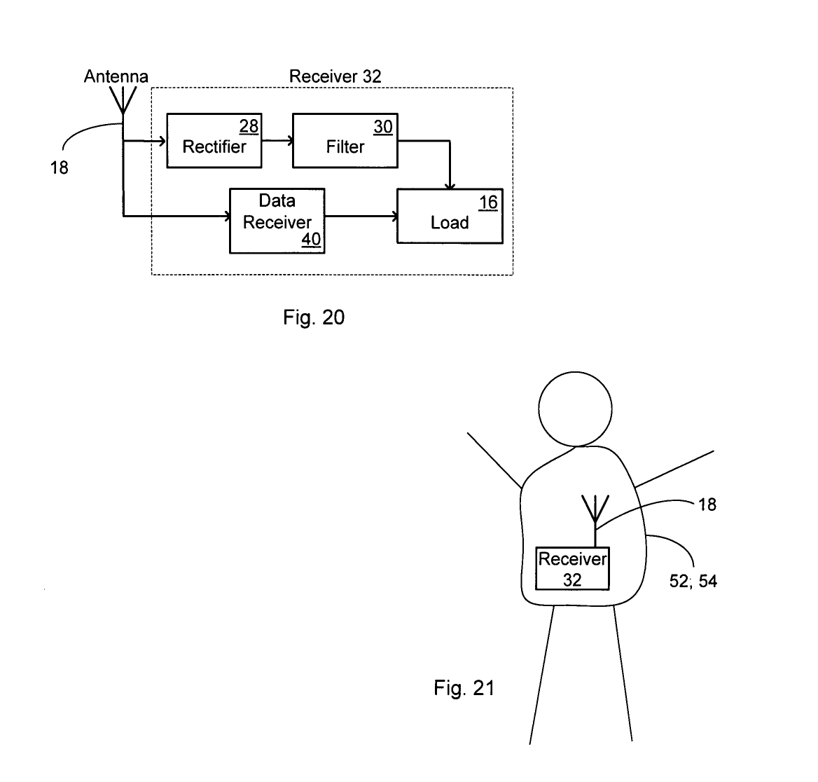

Data could be included within the pulses for communications purposes. This would be accomplished by the inclusion of a data line(s) into the Frequency Generator(s) 20 depicted in the previous figures. This line would be used to modulate the carrier frequency. The receiver 32 would contain an additional apparatus to extract the data from the incoming signal. This is shown in FIG. 20.

The invention should not be confused with power transfer by inductive coupling, which requires the device to be relatively close to the power transmission source. The RFID Handbook by the author Klaus Finkenzeller defines the inductive coupling region as distance between the transmitter and receiver of less than 0.16 times lambda where lambda is the wavelength of the RF wave. The proposed invention can implemented in the near-field (sometimes referred to as inductive) region as well as the far-field region. The far-field region is distances greater than 0.16 times lambda.

It will be understood by those skilled in the art that while the foregoing description sets forth in detail preferred embodiments of the present invention, modifications, additions, and changes might be made thereto without departing from the spirit and scope of the invention.

The invention claimed is:

1. A transmitter for transmitting power wirelessly to a receiver to power a load comprising:
a pulse generator for producing pulses of power; and
a power sensor which can sense when other transmitters are transmitting in order for the generator to transmit the pulses at the appropriate time.

2. A transmitter as described in claim 1 wherein the power sensor is in communication with the pulse generator.

3. A transmitter as described in claim 1 wherein the power sensor is in communication with a microcontroller controlling the pulse generator.

4. A transmitter as described in claim 1 wherein the power sensor is in communication with an analog to digital converter in communication with a microcontroller controlling the pulse generator.

5. A power sensor for a pulse generator of a transmitter which can sense when other transmitters are transmitting in order for the generator to transmit the pulses at the appropriate time comprising:
an antenna; and
an analog to digital converter or a voltage comparator or an input pin.

6. A system for power transmission comprising:
a transmitter which transmits pulses of power and which senses when other transmitters are transmitting in order for the generator to transmit the pulses at the appropriate time; and
a receiver which receives the pulses of power transmitted by the power transmitter to power a load.

7. A system as described in claim 6 wherein the receiver transmits data when the transmitter is not transmitting a pulse.

8. A method for transmitting power to a receiver to power a load comprising the steps of:
producing pulses of power with a pulse generator; and
transmitting the pulses based on a power sensor which can sense when other transmitters are transmitting in order for the generator to transmit the pulses at the appropriate time.

9. An apparatus for transmitting power to a receiver to power a load comprising:
a plurality of transmitters, each of which produce pulses of power and each of which having an associated sensor that can sense when the transmitters are producing the pulses so the associated transmitter can transmit the pulses at the appropriate time which are received by the receiver to power the load.

10. A method for transmitting power to a receiver to power a load comprising the steps of:
producing pulses of power from a plurality of transmitters each having an associated sensor that can sense when the transmitters are producing the pulses so the associated transmitter can transmit the pulses at the appropriate time which are received by the receiver to power the load.

11. A system for power transmission comprising:
a transmitter which transmits pulses of power having an average transmitted power; and
a receiver which receives the pulses of power transmitted by the power transmitter to power a load, the pulses produced by the transmitter yielding voltages at the receiver which are higher than continuous-wave systems having the same average transmitted power as the transmitter.

12. A system for power transmission comprising:
a transmitter which transmits pulses of power; and
a receiver adapted to be disposed in a patient which receives the pulses of power transmitted by the power transmitter to power a load.

13. A system for power transmission comprising:
a transmitter which transmits pulses of power having an average transmitted power; and
a receiver which receives the pulses of power transmitted by the power transmitter to power a load, the pulses produced by the transmitter yielding instantaneous open circuit voltages at the receiver which are higher than continuous-wave systems having the same average transmitted power as the transmitter enabling battery recharging at greater distance.

14. A system for power transmission comprising:
a transmitter which transmits pulses of power having an average transmitted power; and
a receiver which receives the pulses of power transmitted by the power transmitter to power a load, the pulses produced by the transmitter yielding instantaneous open circuit voltages at the receiver which are higher than continuous-wave systems having the same average transmitted power as the transmitter enabling direct powering at greater distance.

15. A system for power transmission comprising:
a transmitter which transmits pulses of power; and
a receiver which receives the pulses of power transmitted by the power transmitter to power a load and transmits data when the transmitter is not transmitting a pulse.

16. A method for transmitting power wirelessly to a receiver comprising the steps of:
sensing power by an RF power sensor; and
transmitting power wirelessly by a transmitter if the power sensed by the sensor is below a threshold.

17. A method as described in claim 16 including the step of waiting to transmit power wirelessly by the transmitter if the power sensed by the sensor is above the threshold.

18. A transmitter as described in claim 1 wherein the pulse generator includes a frequency generator having an output, and an amplifier in communication with the frequency generator.

19. A transmitter as described in claim 18 including an enabler which controls the frequency generator or the amplifier to form the pulses.

20. A transmitter as described in claim 19 wherein the enabler defines a time duration between pulses.

21. A transmitter as described in claim 20 wherein the time duration is greater than one-half of one cycle of the frequency generator output.

22. The transmitter as described in claim 21 wherein the power of the transmitted pulses is equivalent to an average power of a continuous wave power transmission system.

23. A transmitter as described in claim 22 wherein the average power Pavg of the pulses is determined by
$${P}_{AVG} = \frac{{P}_{PEAK} ( {T}_{PULSE} )}{{T}_{PERIOD}} .$$

24. A transmitter as described in claim 1 wherein the pulse generator produces a continuous amount of power between pulses.

25. A transmitter as described in claim 1 wherein the pulse generator produces pulses at different output frequencies sequentially.

26. A transmitter as described in claim 1 wherein the pulse generator produces pulses at different amplitudes.

27. A transmitter as described in claim 26 wherein the pulse generator includes a plurality of frequency generators; an amplifier; and a frequency selector in communication with the frequency generators and the amplifier, that determines and routes the correct frequency from the frequency generators to the amplifier.

28. A transmitter as described in claim 1 wherein the pulse generator transmits data between the pulses.

29. A transmitter as described in claim 1 wherein the pulse generator transmits data in the pulses.

30. A transmitter as described in claim 18 including a gain control which controls the frequency generator or the amplifier to form the pulses.

31. A transmitter as described in claim 30 wherein the gain control defines a time duration between pulses.

32. A system for power transmission comprising:
a transmitter that produces pulses of power; and
a receiver located inside or behind an attenuating medium, wherein the receiver receives the pulses of power in order to power a load.

33. A system for power transmission comprising:
a transmitter that produces output power having an average value; and
a receiver that receives the output power in order to power a load, wherein the load is powered at distances greater than those obtained by a continuous-wave system at an average power level that is the same as the average value.

34. A system as described in claim 33 wherein the load is a battery, a circuit, or an LED.

35. A system for power transmission comprising:
a transmitter which transmits pulses of power; and
a receiver which receives the pulses of power transmitted by the transmitter to power a load, wherein the load has predetermined power requirements, and the transmitter meets the pre-determined power requirements using less average output power than a transmitter outputting a fixed amount of power.

36. A receiver which wirelessly receives pulses of power comprising:
a rectifier which receives the pulses of power, the pulses yielding voltages at the receiver which are higher than continuous-wave power having the same average power as the pulses;
a storage device in electrical communication with the rectifier which is powered by the rectifier and provides a predetermined continuous level of power; and
a load in electrical communication with the storage device and receiving power from the storage device.

37. A receiver which wirelessly receives pulses of power comprising:
a rectifier which receives the pulses of power, the pulses yielding instantaneous open circuit voltages at the receiver which are higher than continuous-wave power having the same average power as the pulses enabling battery recharging at greater distance; and
a battery in electrical communication with the rectifier and receiving power from the rectifier.

38. A receiver which wirelessly receives pulses of power comprising:
a rectifier which receives the pulses of power, the pulses yielding instantaneous open circuit voltages at the receiver which are higher than continuous-wave power having the same average power as the pulses enabling direct powering at greater distance;
a storage device in electrical communication with the rectifier which is powered by the rectifier and provides a predetermined continuous level of power; and
a load in electrical communication with the storage device and receiving power from the storage device.

39. A method for using pulses of power received wirelessly by a receiver comprising the steps of:
receiving the pulses of power by a rectifier of the receiver;
providing by the rectifier energy from the pulses of power; and
powering a load with the energy from the rectifier.
